(19) United States
(12) Patent Application Publication
(10) Pub. No.: US 2026/0023908 A1
(43) Pub. Date: Jan. 22, 2026

(54) Machine Learning-based Wafer Testing Yield Boosting Method and System Capable of Predicting Die-level Wafer Acceptance Test Parameters

(71) Applicant: MEDIATEK INC., Hsinchu City (TW)

(72) Inventors: Tsung-Te Chen, Hsinchu City (TW); Po-Chao Tsao, Hsinchu City (TW); Chi-Ming Lee, Hsinchu City (TW); Chin-Wei Lin, Hsinchu City (TW); Khim Jun Koh, Hsinchu City (TW); Yi-Ju Ting, Hsinchu City (TW); Buo-Chin Hsu, Hsinchu City (TW); Chin-Tang Lai, Hsinchu City (TW); Yung-Teng Lin, Hsinchu City (TW); Ming-Cheng Lee, Hsinchu City (TW); Tung-Hsing Lee, Hsinchu City (TW)

(73) Assignee: MEDIATEK INC., Hsinchu City (TW)

(21) Appl. No.: 19/267,657

(22) Filed: Jul. 14, 2025

Related U.S. Application Data
(60) Provisional application No. 63/671,822, filed on Jul. 16, 2024.

(51) Int. Cl. G06F 30/333; G06F 119/22

(52) U.S. Cl. CPC G06F 30/333; G06F 2119/22

(57) ABSTRACT

A machine learning-based wafer testing yield boosting method includes acquiring a plurality of actual Wafer Acceptance Test (WAT) measurement parameters at a plurality of locations on a wafer from a foundry and a plurality of WAT sensing parameters monitored by a plurality of sensors disposed within the wafer, and inferring a plurality of predicted WAT parameters for a plurality of dies on the wafer based on the plurality of actual WAT measurement parameters and the plurality of WAT sensing parameters by a machine learning model.

### CROSS REFERENCE TO RELATED APPLICATIONS

This application claims the benefit of U.S. Provisional Application No. 63/671,822, filed on Jul. 16, 2024. The content of the application is incorporated herein by reference.

### BACKGROUND

In the conventional method, the System Level Test (SLT) yield is analyzed using Wafer-level WAT (Wafer Acceptance Test) data (for example, 2000 WAT samples). Artificial Intelligence (AI) analysis is employed to identify the WAT items that are most relevant to the SLT yield. Subsequently, the process influencing these WAT items is adjusted.

However, the conventional method has several limitations. First, it relies on Wafer-level WAT, which inherently limits the sample amount. For example, the sample amount is only 2000 for 2000 wafers. Such a limited sample amount restricts the comprehensiveness and accuracy of the AI analysis. Second, when wafer defects are distributed on the edge, the conventional method may fail to analyze the precise SLT yield and WAT parameters.

Furthermore, when utilizing Wafer-level WAT for AI analysis, device speed involves a trade-off between SLT yield and chip performance. Consequently, it is difficult to implement process adjustments based on conventional AI analysis effectively. For example, if the device speed (or relevant WAT parameter) is adjusted, the SLT yield may increase, but the chip performance of the wafer will decrease.

### SUMMARY

In an embodiment, a machine learning-based wafer testing yield boosting method is disclosed. The machine learning-based wafer testing yield boosting method comprises acquiring a plurality of actual Wafer Acceptance Test (WAT) measurement parameters at a plurality of locations on a wafer from a foundry and a plurality of WAT sensing parameters monitored by a plurality of sensors disposed within the wafer, and inferring a plurality of predicted WAT parameters for a plurality of dies on the wafer based on the plurality of actual WAT measurement parameters and the plurality of WAT sensing parameters by a machine learning (ML) model.

In another embodiment, a machine learning-based wafer testing yield boosting system is disclosed. The machine learning-based wafer testing yield boosting system comprises a data collection module configured to acquire data, a processor coupled to the data collection module and configured to perform a die-level WAT training stage and a die-level WAT data prediction stage of an ML model, and a memory coupled to the processor and configured to save the ML model. The data collection module acquires a plurality of actual WAT measurement parameters at a plurality of locations on a wafer from a foundry and a plurality of WAT sensing parameters monitored by a plurality of sensors disposed within the wafer. The ML model infers a plurality of predicted WAT parameters for a plurality of dies on the wafer based on the plurality of actual WAT measurement parameters and the plurality of WAT sensing parameters.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a machine learning-based wafer testing yield boosting system according to an embodiment of the present invention.

FIG. 2A is a flow chart of performing a die-level Wafer Acceptance Test (WAT) data prediction stage by the machine learning-based wafer testing yield boosting system in FIG. 1.

FIG. 2B is a flow chart of performing a key factor identification stage by the machine learning-based wafer testing yield boosting system in FIG. 1.

FIG. 3 is a schematic diagram of measured points of the wafer acquired by the machine learning-based wafer testing yield boosting system in FIG. 1.

FIG. 4 is a schematic diagram of locations of actual WAT measurement parameters and die-based WAT sensing parameters of the machine learning-based wafer testing yield boosting system in FIG. 1.

FIG. 5 is a schematic diagram of an SLT-failure map of the machine learning-based wafer testing yield boosting system in FIG. 1.

FIG. 6 is a flow chart of performing a machine learning-based wafer testing yield boosting method by the machine learning-based wafer testing yield boosting system in FIG. 1.

### DETAILED DESCRIPTION

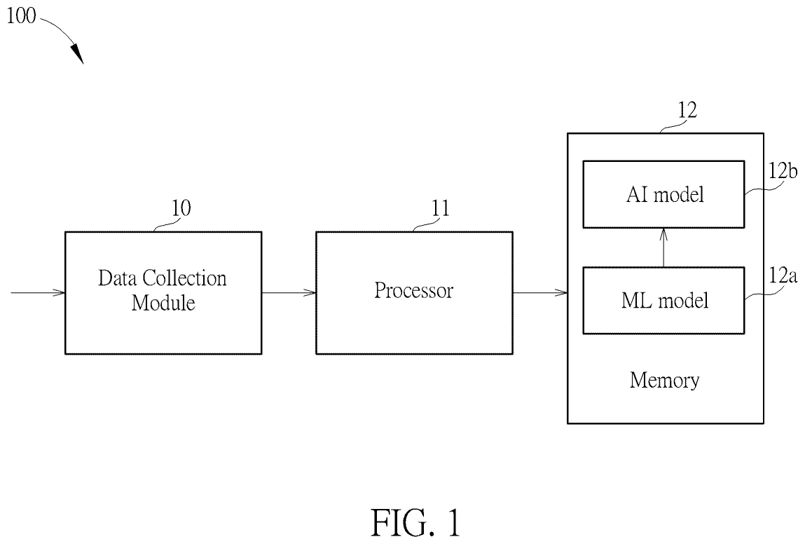

FIG. 1 is a block diagram of a machine learning-based wafer testing yield boosting system 100 according to an embodiment of the present invention. The machine learning-based wafer testing yield boosting system 100 employs a two-stage framework to enhance System Level Test (SLT) yield analysis. The machine learning-based wafer testing yield boosting system 100 leverages Artificial Intelligence (AI) to predict die-level Wafer Acceptance Test (WAT) parameters, generating more die-level WAT parameters than traditional methods. This is achieved by training AI models on the correlations between sensing data monitoring from individual dies and the actual WAT measurements. By predicting die-level WAT parameters uniformly distributed on the wafer, the machine learning-based wafer testing yield boosting system 100 significantly expands the sample amount for subsequent AI analysis, leading to providing accurate analysis of the die-level WAT parameters and SLT yield.

In FIG. 1, the machine learning-based wafer testing yield boosting system 100 includes a data collection module 10, a processor 11, and a memory 12. The data collection module 10 is designed to gather various types of data related to the wafer manufacturing process. In the embodiment, the data collection module 10 collects actual WAT measurement parameters. The actual WAT measurement parameters are measurements taken during the wafer manufacturing phase in a foundry. For example, the actual WAT measurement parameters include saturation current parameters, off-current parameters, threshold voltage parameters, effective capacitance parameters, ring oscillator speed parameters, quiescent current parameters, sheet resistance parameters, and/or contact resistance parameters, used in the process of manufacturing integrated circuits. The processor 11 is coupled to the data collection module 10 for performing a die-level WAT data prediction stage and a key factor identification stage of a machine learning (ML) model. In the embodiment, the machine learning-based wafer testing yield boosting system 100 employs the two-stage framework to enhance SLT yield analysis. The “die-level WAT data prediction stage” is the first stage of the two-stage framework. In this stage, the ML is used for predicting the die-level WAT parameters. The process begins with input data, which is then preprocessed. Then, an auto-cross feature process is applied. Then, the training data is used to train an ML model 12a. After the ML model 12a is fully trained, finally, die-level WAT predictions can be generated. The “die-level WAT data prediction stage” is used for predicting WAT parameters for each individual die on the wafer.

The “key factor identification stage” is the second stage of the two-stage framework. In this stage, the die-level WAT predictions generated in the first stage are utilized. Then, an AI modeling 12b is performed, followed by model selection and hyper-parameter tuning. Particularly, since the input data for this stage is the die-level WAT predictions, the AI model 12a can provide detailed analysis to identify key factors of at least one WAT parameter influencing the SLT yield. Further, in the wafer testing yield boosting system 100, the memory 12 is coupled to the processor 11 and configured to save the ML model 12a and the AI model 12b. In the embodiment, the ML model 12a is established for the die-level WAT data prediction stage. The AI model 12b is established for the key factor identification stage. The ML model 12a and the AI model 12b can be saved in a shared memory space or two different memory spaces. Any technology or hardware modification falls into the scope of the embodiments.

In brief, for the machine learning-based wafer testing yield boosting system 100, the data collection module 10 acquires the plurality of actual WAT measurement parameters at the plurality of locations on the wafer from the foundry and the plurality of WAT sensing parameters monitored by the plurality of sensors disposed within the wafer. The ML model 12a infers the plurality of predicted WAT parameters for the plurality of dies on the wafer based on the plurality of actual WAT measurement parameters and the plurality of WAT sensing parameters. Operational details of the machine learning-based wafer testing yield boosting system 100 are illustrated below.

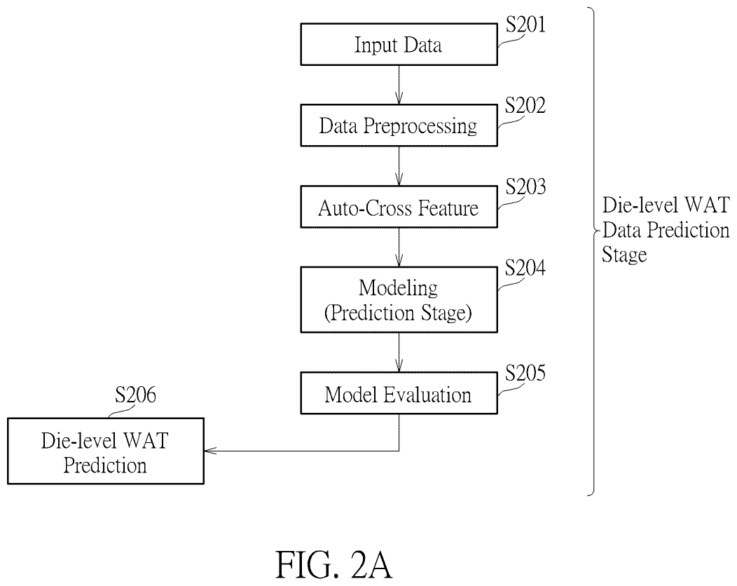

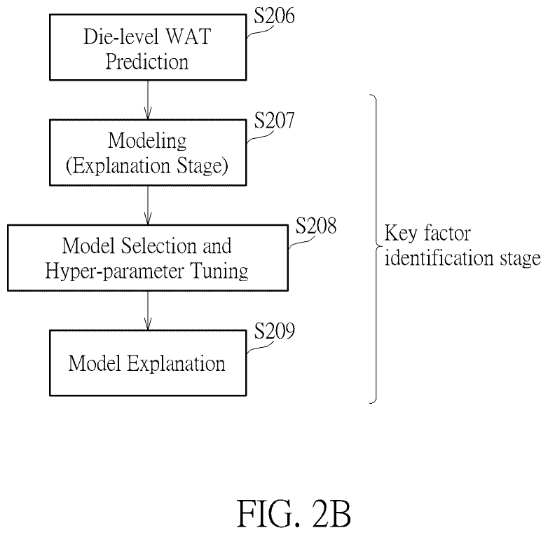

FIG. 2A is a flow chart of performing the die-level WAT data prediction stage by the machine learning-based wafer testing yield boosting system 100. The die-level WAT data prediction stage includes steps S201 to S206. Any technology or hardware modification falls into the scope of the embodiments. Steps S201 to S206 are illustrated below.
Step S201: inputting data to the data collection module 10;
Step S202: preprocessing the inputted data;
Step S203: generating auto-cross features based on the inputted data;
Step S204: establishing, training, and validating the ML model 12a;
Step S205: inferring the predicted WAT parameters;
Step S206: outputting the predicted WAT parameters from the ML model 12a.

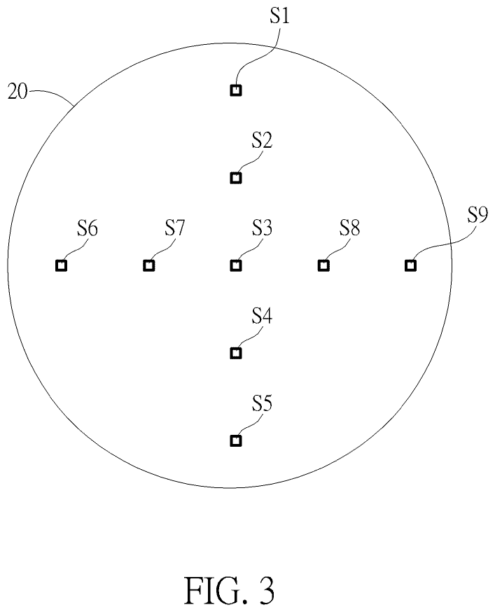

In step S201, the data collection module 10 acquires the inputted data. The inputted data includes the actual WAT measurement parameters measured by the foundry. The foundry takes measurements at specific locations on the wafer. For example, in FIG. 3, the foundry measures actual WAT measurement parameters at nine points on each wafer. In addition to the actual WAT measurement parameters, the inputted data also includes WAT sensing parameters monitored by sensors located on the dies (individual chips) themselves. Each wafer has a plurality of sensors (e.g., 500 to 1000 sensors). These sensors monitor various WAT sensing parameters related to the die's characteristics. In step S202, the data preprocessing is akin to a “data cleaning” process. The inputted data corresponding to the actual WAT measurement parameters and the WAT sensing parameters may contain anomalies or inconsistencies that could negatively impact the ML model 12a's training and predictive accuracy. For instance, the inputted data may contain outliers or missing values. These outliers are data points that deviate significantly from the general pattern of the data and could skew the ML model 12a's learning. Similarly, missing values, where certain sensor readings are unavailable, can create gaps in the dataset. The “data preprocessing” step addresses these issues by employing techniques to handle outliers, impute missing values, or remove corrupted data, ensuring that only data points that can contribute to the ML model 12a's learning process are retained.

In step S203, the auto-cross features are generated based on the inputted data by the processor 11. In the embodiment, the auto-cross features involve generating new input features for the ML model 12a by combining existing input data features, such as features of the actual WAT measurement parameters and the WAT sensing parameters. The “auto-cross features” generating process explores potential relationships between these individual features. For example, it may multiply one actual WAT measurement parameter's value with a specific sensor's reading (WAT sensing parameter), or it may take the ratio of two WAT sensing parameters. By generating the auto-cross features, the ML model 12a is given a richer set of information for learning to identify complex relationships and patterns. In step S204, the processor 11 establishes the ML model 12a, and trains the ML model 12a based on the plurality of actual WAT measurement parameters and a portion of sensing parameters (e.g., training data set) in conjunction with a suitable ML algorithm. The training process allows the ML model 12a to learn the complex relationships and patterns between the input features (e.g., actual WAT measurement parameters, sensing parameters, and their combinations) and the target output (die-level predicted WAT parameters). Further, the processor 11 validates the ML model 12a based on another portion of sensing parameters (e.g., validation data set, referred to as WAT validation parameters) to determine if the ML model 12a is fully trained.

In step S205, after the ML model 12a is fully trained, it implies that the ML model 12a is reliable and accurate in its predictions of die-level WAT parameters. It should be understood that the data used for testing ML model performance is separate from the data used for training the ML model 12a. This is to ensure an unbiased assessment of the ML model 12a's ability to generalize to new, unseen data. Then, the ML model 12a infers the plurality of predicted WAT parameters for the plurality of dies on the wafer. Finally, in step S206, the predicted WAT parameters are outputted from the ML model 12a.

In the embodiment, the “die-level WAT data prediction stage” refers to a series of steps S201 to S206 focused on generating predicted WAT parameters for each die of the wafer. In essence, the die-level WAT data prediction stage uses ML technology for predicting numerous WAT parameters at the die level, providing a richer dataset for subsequent AI analysis.

FIG. 2B is a flow chart of performing a key factor identification stage by the machine learning-based wafer testing yield boosting system 100. The key factor identification stage is performed after the die-level WAT data prediction stage. The key factor identification stage includes steps S207 to S209. Any technology or hardware modification falls into the scope of the embodiments. Steps S207 to S209 are illustrated below.
Step S207: performing a model explanation stage;
Step S208: performing a model selection and a hyper-parameter tuning stage;
Step S209: outputting rankings of the plurality of predicted WAT parameters based on a plurality of importance values.

In step S207, the model explanation stage is about understanding and interpreting a trained AI model 12b based on the predicted WAT parameters, particularly how different features of the predicted WAT parameters influence the AI model 12b's predictions. Further, the Model explanation stage of step S207 involves using techniques to analyze the AI model 12b's internal workings and determine the relative importance or contribution of different input features (predicted WAT parameters) to the AI model 12b's output. For example, this model explanation stage can infer which specific WAT parameters have high correlations with the SLT yield. Step S208 refers to a process of optimizing the AI model 12b to achieve the best possible performance. Step S208 involves two key aspects: model selection and hyper-parameter tuning. The model selection stage involves choosing the most appropriate type of machine learning algorithm for the task of predicting WAT parameters having high correlation with the SLT yield. In the hyper-parameter tuning stage, once a machine learning algorithm is selected, it has parameters that need to be configured. These parameters, often called “hyper-parameters”, are not initially learned from current data but are configured before the training process. The hyper-parameter tuning stage can adjust the optimal values for these hyper-parameters to maximize the AI model 12b's performance. In step S209, the AI model 12b outputs rankings of the plurality of predicted WAT parameters based on a plurality of importance values.

In other words, in the key factor identification stage, the “key factor” refers to WAT parameters having high correlations with the SLT yield. After the data collection module 10 acquires the SLT results for the plurality of dies on the wafer, the processor 11 analyzes correlations between the plurality of predicted WAT parameters and the SLT yield based on the plurality of predicted WAT parameters and the plurality of SLT results. For example, given N wafers (e.g., N=2000), the SLT results on a certain die include pass or fail information acquired from an SLT station. Therefore, the processor 11 can acquire the SLT yield on a certain die by analyzing N wafers. Based on this SLT yield (i.e., 90%), the processor 11 can use the AI model 12b for generating a plurality of importance values corresponding to the plurality of predicted WAT parameters based on the correlations between the plurality of predicted WAT parameters and the SLT yield. Then, the processor 11 ranks the plurality of predicted WAT parameters based on the plurality of importance values. Finally, to increase the SLT yield, the processor 11 selects a WAT parameter to be adjusted from the plurality of predicted WAT parameters after the plurality of predicted WAT parameters are ranked. It should be understood that the “WAT parameter to be adjusted” is identified as having a high degree of influence on the SLT yield, while making adjustments to this WAT parameter does not negatively impact the overall performance of the devices on the wafer. For example, the processor 11 can select the WAT parameter as the resistance of the fourth metal layer (M4_Rs) that is irrelevant to a device speed of the wafer and has an importance value higher than a threshold. Here, the device refers to electronic components (such as transistors) fabricated on a semiconductor wafer. The device speed can be regarded as an integrated circuit (IC) component speed.

FIG. 3 is a schematic diagram of measured points of the wafer acquired by the machine learning-based wafer testing yield boosting system 100. FIG. 3 provides a top-down view of a wafer 20, and represents the specific locations where actual WAT measurement parameters are measured. The wafer 20 is represented by a circular shape. Nine distinct measured points S1 to S9 are located on wafer 20. The measured points S1 to S9 are distributed across the surface of wafer 20 in a specific pattern. For example, in FIG. 3, the pattern formed by the measured points S1 to S9 is a cross shape. In another embodiment, the pattern formed by the measured points S1 to S9 is concentric circles. It should be understood that the foundry can measure actual WAT measurement parameters (e.g., saturation current, off-current, threshold voltage, etc.) at each of these measured points S1 to S9. The data collection module 10 collects the actual WAT measurement parameters of the measured points S1 to S9 for ML analysis of the die-level WAT data prediction stage previously mentioned.

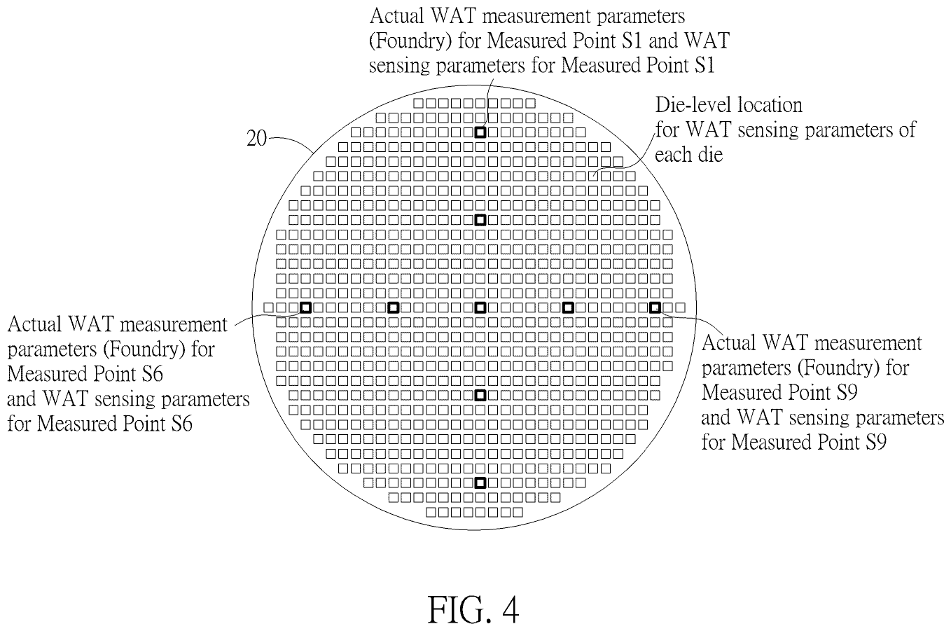

FIG. 4 is a schematic diagram of locations of actual WAT measurement parameters and die-based WAT sensing parameters of the machine learning-based wafer testing yield boosting system 100. FIG. 4 provides a top-down view of the wafer 20, and represents the relationship between the measured points S1 to S9 where actual WAT measurement parameters are measured by the foundry and a distribution of die-level locations for WAT sensing parameters monitored by sensors. In FIG. 4, the wafer 20 includes a plurality of dies. These dies are the functional units of the ICs. Their arrangement is a grid-like pattern across the wafer 20's surface, indicating the high density of components on a single wafer (such as 500 to 1000 dies per wafer). Each sensor corresponds to a die on the wafer 20. The sensors are uniformly distributed on the wafer 20. Further, as illustrated in FIG. 3, actual WAT measurement parameters of the measured points S1 to S9 acquired from the foundry are introduced. Additionally, locations of the measured points S1 to S9 and some die-level locations for monitoring WAT sensing parameters by the sensors on the wafer 20 are overlapped. In other words, locations for detecting the portion of sensing parameters are the same as locations for detecting the plurality of actual WAT measurement parameters. In brief, the foundry-measured WAT parameters (actual WAT measurement parameters) provide accurate, direct measurements of electrical characteristics at locations of nine measured points S1 to S9 of the wafer. The die-level WAT sensing parameters (WAT sensing parameters), obtained from sensors integrated into the dies themselves, provide a denser and more distributed data set (500 to 1000 die locations per wafer) of data across the wafer 20. By combining actual WAT measurement parameters and WAT sensing parameters, the ML model 12a can be trained to predict die-level WAT parameters across the entire wafer, even at locations where the foundry does not perform direct measurements. As a result, the machine learning-based wafer testing yield boosting system 100 provides a more comprehensive and detailed analysis of die-level WAT parameters and SLT yield.

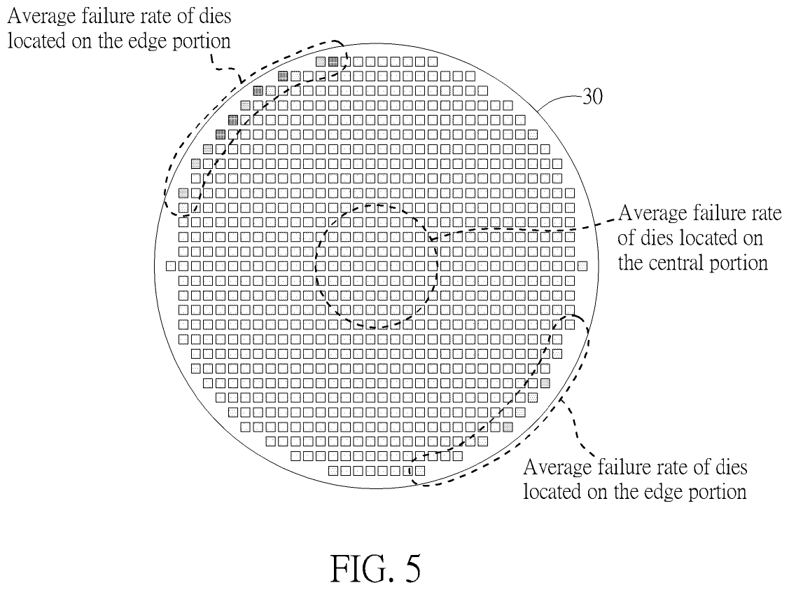

FIG. 5 is a schematic diagram of an SLT-failure map 30 of the machine learning-based wafer testing yield boosting system 100. The SLT-failure map 30 illustrates a spatial distribution of SLT failures across the wafer 20. The processor 11 can generate the SLT-failure map 30 of N wafers based on pass or fail information for all dies of the N wafers. N is a positive integer greater than two (e.g., N=2000 wafers). FIG. 5 provides a visual representation of the failure patterns observed during the testing of ICs fabricated on the wafer 20. The SLT-failure map 30 is presented as a circular representation of the wafer 20, consistent with the physical shape of semiconductor wafers. The wafer's surface is segmented into a grid-like structure, wherein each segment corresponds to a die, representing an individual IC. The gray level of each segment indicates the failure rate of the corresponding die. The lighter shades represent lower failure rates. The darker shades represent higher failure rates. In FIG. 5, the SLT-failure map 30 shows distinct regions with varying failure rate characteristics. For example, the central portion of the wafer 20, exhibits a lighter shade, indicating a lower average failure rate of dies located within this region. In contrast, the edge portions of the wafer, exhibit darker shades, signifying a higher average failure rate. The SLT-failure map 30 clarifies the spatial trend of failure rates across the wafer 20, emphasizing the increased failure incidence at the wafer 20's periphery. Therefore, in FIG. 5, the SLT-failure map 30 carries information of the non-uniform distribution of die failures. Dies located at the edge portions of the wafer 20 are statistically more prone to failure compared to those located at the central portion. In the embodiment, the SLT-failure map 30 can be used for model explanation by informing the identification of key factors influencing SLT yield and guiding process adjustments to mitigate edge-related failures.

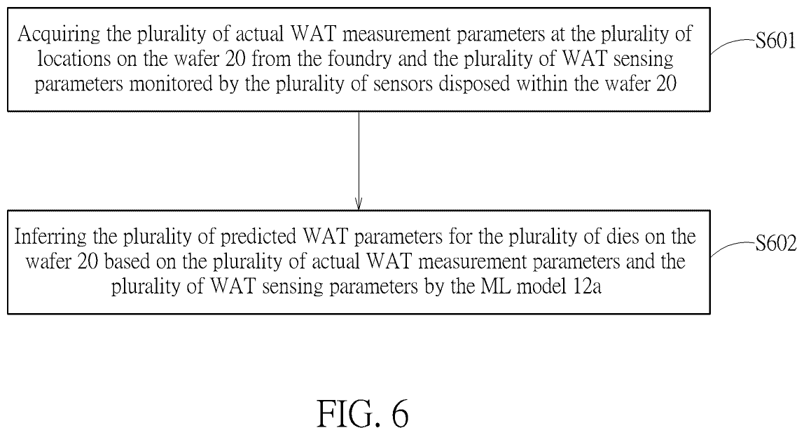

FIG. 6 is a flow chart of performing a machine learning-based wafer testing yield boosting method by the machine learning-based wafer testing yield boosting system 100. The machine learning-based wafer testing yield boosting method includes steps S601 and S602. Any technology or hardware modification falls into the scope of the embodiments. Steps S601 and S602 are illustrated below.
Step S601: acquiring the plurality of actual WAT measurement parameters at the plurality of locations on the wafer 20 from the foundry and the plurality of WAT sensing parameters monitored by the plurality of sensors disposed within the wafer 20;
Step S602: inferring the plurality of predicted WAT parameters for the plurality of dies on the wafer 20 based on the plurality of actual WAT measurement parameters and the plurality of WAT sensing parameters by the ML model 12a.

Details of steps S601 and S602 are previously illustrated. Thus, they are omitted here. The machine learning-based wafer testing yield boosting system 100 presents several significant advantages over conventional methods for analyzing SLT yield and optimizing wafer manufacturing processes. These advantages primarily stem from the system's ability to generate and utilize a more comprehensive and precise dataset of WAT parameters. In conventional methods, when analyzing the SLT yield, data acquisition is limited by the number of measurement points on each wafer. For example, if the wafer amount is 2000 (N=2000), the conventional method typically involves taking WAT parameter measurements at only nine discrete locations on each wafer. To simplify the analysis, a representative WAT parameter value for the entire wafer is often derived by calculating the median of the WAT parameters obtained from these nine measured points. Consequently, each wafer is effectively represented by a single data point for WAT parameter analysis. Therefore, the conventional method may introduce substantial inaccuracies, particularly when the failure distribution across the dies on the wafer is “non-uniform”. Specifically, if failures are concentrated at specific locations, such as the edges of the wafer, the median value may not accurately reflect the WAT parameter characteristics associated with those failure-prone areas.

In contrast, the wafer testing yield boosting system 100 of the embodiments leverages machine learning to predict die-level WAT parameters. The embodiment allows for a significantly higher density of WAT parameter data points across the wafer. Instead of a single median value, the wafer testing yield boosting system 100 generates predicted WAT parameters for each individual die. In one embodiment, it is assumed that the wafer includes 500 to 1000 dies. The wafer testing yield boosting system 100 can effectively generate 500 to 1000 measured points of WAT parameters for each wafer. Therefore, when the wafer amount is 2000 (N=2000), the total number of measured points available for subsequent WAT importance analysis ranges from 2000×500 to 2000×1000.

In summary, the embodiments disclose a machine learning-based wafer testing yield boosting method and a machine learning-based wafer testing yield boosting system. The machine learning-based wafer testing yield boosting system can increase the data granularity, enabling a more precise analysis of WAT parameter importance. By utilizing die-level WAT parameters, the machine learning-based wafer testing yield boosting system can accurately correlate key WAT parameters with the performance and the SLT yield of individual dies. As a result, the machine learning-based wafer testing yield boosting system can accurately identify key WAT parameters (key factors) that significantly influence SLT yield, even in cases where failure distributions on the wafer are non-uniform.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A machine learning-based wafer testing yield boosting method comprising:
acquiring a plurality of actual Wafer Acceptance Test (WAT) measurement parameters at a plurality of locations on a wafer from a foundry and a plurality of WAT sensing parameters monitored by a plurality of sensors disposed within the wafer; and
inferring a plurality of predicted WAT parameters for a plurality of dies on the wafer based on the plurality of actual WAT measurement parameters and the plurality of WAT sensing parameters by a machine learning (ML) model.

2. The method of claim 1, wherein acquiring the plurality of actual WAT measurement parameters at the plurality of locations on the wafer from the foundry, is acquiring the plurality of actual WAT measurement parameters at nine locations uniformly distributed on the wafer from the foundry.

3. The method of claim 1, wherein each sensor corresponds to a die on the wafer, and the plurality of sensors are uniformly distributed on the wafer.

4. The method of claim 1, wherein inferring the plurality of predicted WAT parameters for the plurality of dies on the wafer based on the plurality of actual WAT measurement parameters and the plurality of WAT sensing parameters by the ML model comprises:
training the ML model based on the plurality of actual WAT measurement parameters and a portion of sensing parameters; and
inferring the plurality of predicted WAT parameters for the plurality of dies on the wafer by the ML model after the ML model is fully trained;
wherein locations for detecting the portion of sensing parameters are the same as locations for detecting the plurality of actual WAT measurement parameters.

5. The method of claim 4, further comprising:
validating the ML model based on a plurality of WAT validation parameters to determine if the ML model is fully trained.

6. The method of claim 1, further comprising:
acquiring a plurality of System Level Test (SLT) results for the plurality of dies on the wafer;
analyzing correlations between the plurality of predicted WAT parameters and an SLT yield based on the plurality of predicted WAT parameters and the plurality of SLT results; and
generating a plurality of importance values corresponding to the plurality of predicted WAT parameters based on the correlations between the plurality of predicted WAT parameters and the SLT yield.

7. The method of claim 6, wherein acquiring the plurality of SLT results for the plurality of dies on the wafer, is acquiring pass or fail information for each die of the wafer from an SLT station.

8. The method of claim 7, further comprising:
generating an SLT-failure map of N wafers based on pass or fail information for all dies of the N wafers;
wherein an average failure rate of dies located on edge portions of the N wafers is greater than an average failure rate of dies located on central portions of the N wafers, and N is a positive integer greater than two.

9. The method of claim 6, further comprising:
ranking the plurality of predicted WAT parameters based on the plurality of importance values; and
selecting a WAT parameter from the plurality of predicted WAT parameters after the plurality of predicted WAT parameters are ranked; and
adjusting the WAT parameter to increase the SLT yield.

10. The method of claim 9, wherein selecting the WAT parameter from the plurality of predicted WAT parameters comprises:
selecting a WAT parameter that is irrelevant to a device speed of the wafer and has an importance value higher than a threshold.

11. A machine learning-based wafer testing yield boosting system comprising:
a data collection module configured to acquire data;
a processor coupled to the data collection module and configured to perform a die-level Wafer Acceptance Test (WAT) data prediction stage and a key factor identification stage of a machine learning (ML) model; and
a memory coupled to the processor and configured to save the ML model;
wherein the data collection module acquires a plurality of actual WAT measurement parameters at a plurality of locations on a wafer from a foundry and a plurality of WAT sensing parameters monitored by a plurality of sensors disposed within the wafer, and the ML model infers a plurality of predicted WAT parameters for a plurality of dies on the wafer based on the plurality of actual WAT measurement parameters and the plurality of WAT sensing parameters.

12. The system of claim 11, wherein the data collection module acquires the plurality of actual WAT measurement parameters at nine locations uniformly distributed on the wafer from the foundry.

13. The system of claim 11, wherein each sensor corresponds to a die on the wafer, and the plurality of sensors are uniformly distributed on the wafer.

14. The system of claim 11, wherein the processor trains the ML model based on the plurality of actual WAT measurement parameters and a portion of sensing parameters, the ML model infers the plurality of predicted WAT parameters for the plurality of dies on the wafer by the ML model after the ML model is fully trained, and locations for detecting the portion of sensing parameters are the same as locations for detecting the plurality of actual WAT measurement parameters.

15. The system of claim 14, wherein the processor validates the ML model based on a plurality of WAT validation parameters to determine if the ML model is fully trained.

16. The system of claim 11, wherein the data collection module acquires a plurality of System Level Test (SLT) results for the plurality of dies on the wafer, the processor analyzes correlations between the plurality of predicted WAT parameters and an SLT yield based on the plurality of predicted WAT parameters and the plurality of SLT results, and the processor generates a plurality of importance values corresponding to the plurality of predicted WAT parameters based on the correlations between the plurality of predicted WAT parameters and the SLT yield.

17. The system of claim 16, wherein the data collection module acquires pass or fail information for each die of the wafer from an SLT station.

18. The system of claim 17, wherein the processor generates an SLT-failure map of N wafers based on pass or fail information for all dies of the N wafers, an average failure rate of dies located on edge portions of the N wafers is greater than an average failure rate of dies located on central portions of the N wafers, and N is a positive integer greater than two.

19. The system of claim 16, wherein the processor ranks the plurality of predicted WAT parameters based on the plurality of importance values, the processor selects a WAT parameter from the plurality of predicted WAT parameters after the plurality of predicted WAT parameters are ranked, and the WAT parameter is adjusted to increase the SLT yield.

20. The system of claim 19, wherein the processor selects a WAT parameter that is irrelevant to a device speed of the wafer and has an importance value higher than a threshold.
